(19) United States
(12) Patent Application Publication
(10) Pub. No.: US 2019/0105862 A1
(43) Pub. Date: Apr. 11, 2019

(54) SAFE CONTROL APPARATUS AND METHOD OF ADJUSTING THE STROKE LENGTH OF AN ECCENTRIC PRESS

(71) Applicant: SICK AG, Waldkirch (DE)

(72) Inventors: Mathias AMS, Waldkirch (DE); Jörg MODDEMANN, Waldkirch (DE); Fabian MERKLER, Waldkirch (DE)

(21) Appl. No.: 16/145,789

(22) Filed: Sep. 28, 2018

(30) Foreign Application Priority Data
Oct. 9, 2017 (EP) 17195371.4

(51) Int. Cl. B30B 1/26; B30B 15/14

(52) U.S. Cl. CPC B30B 1/263; B30B 15/148

(57) ABSTRACT

A safe control apparatus (10) for adjusting the stroke length of an eccentric press (100), wherein the eccentric press (100) has a plunger (102) that is driven via a connecting rod (104) by an eccentric system (106) that comprises an eccentric shaft (108) and an eccentric bushing (114) that can be released from one another and then rotated against one another for the adjustment of the stroke length; wherein the control apparatus (10) has an encoder (12) for determining the rotational position of the eccentric shaft (108) and a control logic (10) to generate a first switching signal at at least one first rotational position (BDC, TDC). The control logic (10) is here configured to automatically readjust the first rotational position (BDC, TDC) on an adjustment of the stroke length.

The invention relates to a safe control apparatus for adjusting the stroke length of an eccentric press, wherein the eccentric press has a plunger that is driven via a connecting rod by an eccentric system that comprises an eccentric shaft and an eccentric bushing that can be released from one another and then rotated against one another for the adjustment of the stroke length; wherein the control apparatus has an encoder for determining the rotational position of the eccentric shaft and a control logic to generate a first switching signal at at least one first rotational position. The invention further relates to a method of adjusting the stroke length of an eccentric press that has a plunger that is driven via a connecting rod by an eccentric system that comprises an eccentric shaft and an eccentric bushing that are released from one another and are rotated against one another for the adjustment of the stroke length, with the rotational position of the eccentric shaft being determined in operation by an encoder and with a switching signal being generated on a respective reaching of at least one rotational position.

Presses are used everywhere where metal sheets are shaped, typically in the automotive sector or at suppliers, for instance of housing parts such as those of washing machines. In operation, the material is supplied from the front and this region is secured by a light grid and sometimes mechanically. If the press works automatically, the securing ensures that no person comes into dangerous proximity. In manual operation, an operator inserts the material and starts the pressing process. The light grid stops during the downward movement as soon as it recognizes an intervention. The light grid can be deactivated (muted) in the non-hazardous upward movement. A special manual mode of operation is the setting up of the press where the control takes place by a safe two-handed switch while the other safeguards are deactivated.

An eccentric press is typically driven by a motor and by a flywheel, with a combined clutch and brake with a pneumatic control moving and stopping the eccentric press. The plunger of the eccentric press is moved up and down via a connecting rod by an eccentric system whose eccentric shaft is connected to the flywheel via a transmission.

The eccentric shaft is seated in an eccentric bushing. The connection is shape matched during operation and the eccentric system can be considered as a unit. To adjust the stroke length of the eccentric press, the eccentric shaft is pneumatically or hydraulically released from the eccentric bushing and is rotated against it so that the length of the eccentric system is changed. The eccentric system is subsequently connected again, with this only being possible in specific angular steps due to the shape matching.

There are three switching points relevant to the press control and to the safeguarding measures in a pressing cycle. At the top dead center (TDC), the movement is stopped, at least in manual operation, before a new stroke is initiated. The press then must have stopped at the latest at an overrun point (SCC); otherwise, there is a defect in the drivetrain and the press has to be switched off. At a bottom dead center (BDC), the actual work movement is concluded; the protective device or the light grid can be deactivated for the subsequent upward movement.

These three switching points are typically generated by a mechanical cam switch. A cam disk rotates therein with the eccentric shaft whose cams trigger contact switches in corresponding rotational positions.

If the stroke length of the press is now adjusted, the positions of the three switching points BDC, SCC, and TDC are thus also changed. The cam switch therefore has to be readjusted by the machine operator. This is a laborious, manual process, particularly since the cam switch is as a rule only accessible with difficulty after climbing up ladders to the upper part of the press or even after removing housing parts. In addition, the readjustment of the switching points is fully the responsibility of the machine operator without supporting tools for functional safety. The procedure is prone to error, time-consuming, unproductive, and brings along risks of accident overall.

There is also the proposal in the prior art to replace the mechanical cam switch by a rotary encoder that monitors the rotational position of the eccentric shaft and generates switching signals in predefined rotational positions. It is, however, always still necessary here to reset the switching points after an adjustment of the stroke length. For this purpose, the press has to be manually traveled into a previously defined confirmation position to teach the respective switching point there, for example, by pressing a button. The switching point TDC or BDC is typically selected for this purpose. It has thus admittedly been possible to replace the mechanical cam switch. However, the procedure remains laborious and the safety is still the sole responsibility of the machine operator.

It is therefore the object of the invention to improve the monitoring of an eccentric press.

This object is satisfied by a safe control apparatus and by a method of adjusting the stroke length of an eccentric press in accordance with the respective independent claim. The eccentric press has, as described in the introduction, an eccentric system having an eccentric shaft and an eccentric bushing that moves a plunger up and down via a connecting rod. The eccentric shaft can be released from the eccentric bushing and rotated against it for adjusting the stroke length. A control logic generates a switching signal at at least one critical point within a cycle of the press movement. This does not take place via a mechanical cam switch, but rather electronically with the aid of a rotary encoder that monitors the rotational movement of the eccentric shaft. The invention now starts from the basic idea of automatically readjusting the switching point after an adjustment of the stroke length. The first rotational position is here redetermined automatically to compensate the changes that occur due to the rotation of the eccentric shaft against the eccentric bushing.

The invention has the advantage that the mechanical cam switch is replaced with a combination of a safe sensor system and control logic or process signals. This so-to-say virtual cam switch is readjusted with the stroke adjustment without manual interventions in accordance with the invention. The productivity and ergonomics of the system are thereby increased and operating errors and other risks of accident are simultaneously eliminated. The solution in accordance with the invention is here also still less expensive than other systems of automatic stroke adjustment.

The control logic is preferably configured to generate the first switching signal at a bottom dead center and a second switching signal at a second rotational position at a top dead center of the eccentric press. The two switching points explained in the introduction of TDC where the eccentric press stops before a new stroke and of BDC where an additional safety apparatus such as a light grip can be deactivated or muted for the upward movement are thus monitored. Both rotational positions are readjusted on a stroke adjustment.

The control logic is preferably configured to generate a third switching signal at a third rotational position at an overrun point. This is the third switching point explained in the introduction after top dead center at which the press has to be stopped at the latest. Otherwise, an error is present and the further operation of the press is immediately disabled.

The control logic is preferably configured to determine the rotational positions relative to one another. There has to be an absolute reference point for this purpose, preferably one of the rotational positions such as the top dead center TDC. Rotational positions or switching positions are for this purpose determined relatively as offset angles. This has the advantage that they do not have to be separately readjusted, but are rather automatically adapted with the reference point. For example, the overrun point can be disposed 15° after the top dead center TDC such that the overrun point is automatically readjusted with the TDC.

The control logic preferably has a table or a calculation rule that associates a respective correction angle for the first rotational position to possible angles the eccentric shaft and the eccentric bushing can adopt with respect to one another for the adjustment of the stroke length. On an adjustment of the stroke length, the required correction angle is thus determined and the rotational positions are readjusted and adapted to the new stroke length with their aid. In principle, the correction angle can be calculated from the geometries of the eccentric system using trigonometric relationships and the safety apparatus can use this calculation rule. There are, however, typically only comparatively few settable stroke lengths so that it is often simpler to provide a table instead. The calculation rule can then be used in a preparatory manner by the press manufacturer, for example, to generate the table. It is clear that all the correction angles have to be reliably determined because otherwise no reliable readjustment of switching points is possible.

The encoder is preferably configured as a safe absolute rotary encoder. Safe in the sense of machine safety is to be understood, for example, in that the absolute encoder corresponds to the highest safety category 4. Safety can in particular be acquired in that a two-channel subsystem of diverse and redundant encoders is used that are each per se not necessarily safe on their own. An incremental encoder is not sufficient to determine the rotational positions for the switching points. If measurements are made incrementally from a fixed reference point, this would functionally be an absolute encoder if the required measures are taken that the starting reference is correctly taken into account at all times.

The safety control monitoring preferably has a position monitoring sensor for the eccentric bushing. For this purpose, in particular a safe absolute rotary encoder or a diverse and redundant subsystem of two encoders can be used. The readjustment of the switching points depends on the rotational positions of both components of the eccentric system so that the position of the eccentric bushing is preferably also monitored.

Even more preferably, the position monitoring sensor is configured as a safety position switch that recognizes a blockage of the eccentric bushing. The recognition preferably takes place indirectly in that the position monitoring sensor has to remain activated during the stroke adjustment. An adjustment of the stroke length per se is thus equally simplified as is the readjustment of the switching points since one degree of freedom of the eccentric system is fixed. The desired position for the new stroke length can thus be achieved solely by rotating the eccentric shaft and no movement of the eccentric bushing has to be taken into account on the readjustment of the switching points.

The safety control apparatus preferably has an eccentric separation monitoring sensor that recognizes whether the eccentric shaft and the eccentric bushing are released from one another or not. The eccentric separation monitoring sensor can be configured as a contactless safety switch or two mechanical position switches are used. Due to its monitoring, the eccentric system cannot be adjusted without being noticed and is released exactly when a stroke adjustment is carried out.

The control logic is preferably configured to recognize whether an angle between the eccentric shaft and the eccentric bushing selected on the adjustment is permissible. The eccentric shaft only latches in the eccentric bushing in a shape matched manner again in specific rotational positions. It is therefore sensible to check whether a desired or achieved angle between the eccentric shaft and the eccentric bushing is mechanically possible at all and is provided for a stroke adjustment. This check is omitted with an alternative force-fitting connection of the eccentric shaft and the eccentric bushing and with a continuous adjustment of the stroke length.

The control logic is preferably configured to automatically adjust the stroke length. Only a control command that a stroke length adjustment is carried out and possibly the new stroke length to be set are thus transmitted to the safety control apparatus. The safety control apparatus then autonomously takes care of both the setting of the new stroke length and the readjustment of the switching points, whereas the control logic autonomously works through the process steps of the stroke adjustment and transmits status information to the safety control. The procedure of the stroke adjustment, for example, includes the rotation of the eccentric shaft or traveling the press to specific positions such as the top dead center. At the end of the adjustment procedure, the safety control transmits the set stroke length to the control logic; a further check by the process itself can take place here. This is, however, not necessary for the achieving of the safety level aimed for.

The method in accordance with the invention can be further developed in a similar manner and shows similar advantages in so doing. Such advantageous features are described in an exemplary, but not exclusive manner in the subordinate claims dependent on the independent claims.

In the method in accordance with the invention, a desired stroke length is preferably specified for the automatic adjustment of the stroke length and the eccentric shaft is thereupon rotated by the required angle against the eccentric bushing. The desired stroke length is preferably transmitted as one of the possible stages in which the eccentric system can latch. At the same time, the switching points are also readjusted, with here no time sequence having to be fixed; the readjustment can take place as a preceding step, as a subsequent step, or as a simultaneous step.

The eccentric press is preferably first moved into a position suitable for the adjustment of the stroke length. This is preferably the position in which the current stroke length was also set. This position is defined via the mechanical design and is stored in the safety control. A comparison takes place in the safety control whether the current position of the eccentric shaft corresponds to the stored desired position, i.e. to the current stroke length position. A check is furthermore made that the eccentric bushing is likewise in the expected position or setting.

The eccentric shaft is preferably released from the eccentric bushing and the eccentric bushing is blocked; the eccentric press is then driven until the eccentric shaft is rotated by the required angle against the eccentric bushing, and subsequently the eccentric shaft is again connected to the eccentric bushing. These steps are reliably monitored by the sensors of the safety apparatus and the switching points or the rotational positions for generating switching signals are readjusted.

The invention will be explained in more detail in the following also with respect to further features and advantages by way of example with reference to embodiments and to the enclosed drawing. The Figures of the drawing show in:

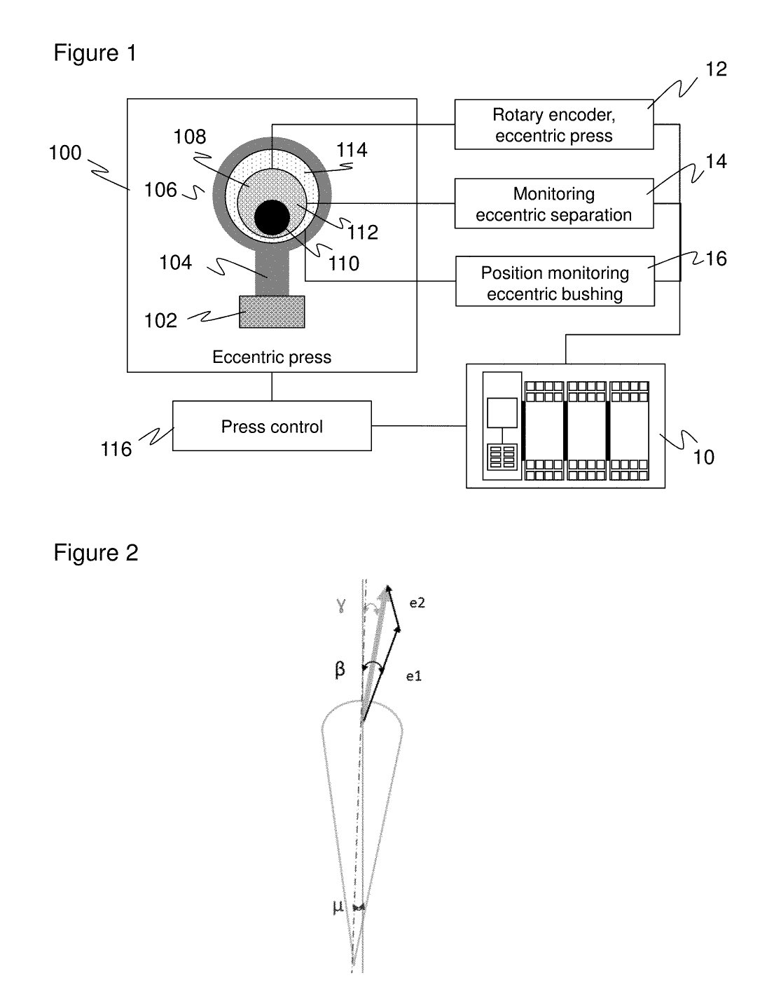

FIG. 1 a block diagram of an eccentric press whose stroke length is adjustable by means of a safety control and by means of a connected sensor system including the readjustment of switching points;

FIG. 2 a diagram that explains the angle in the eccentric system on the adjustment of the stroke length;

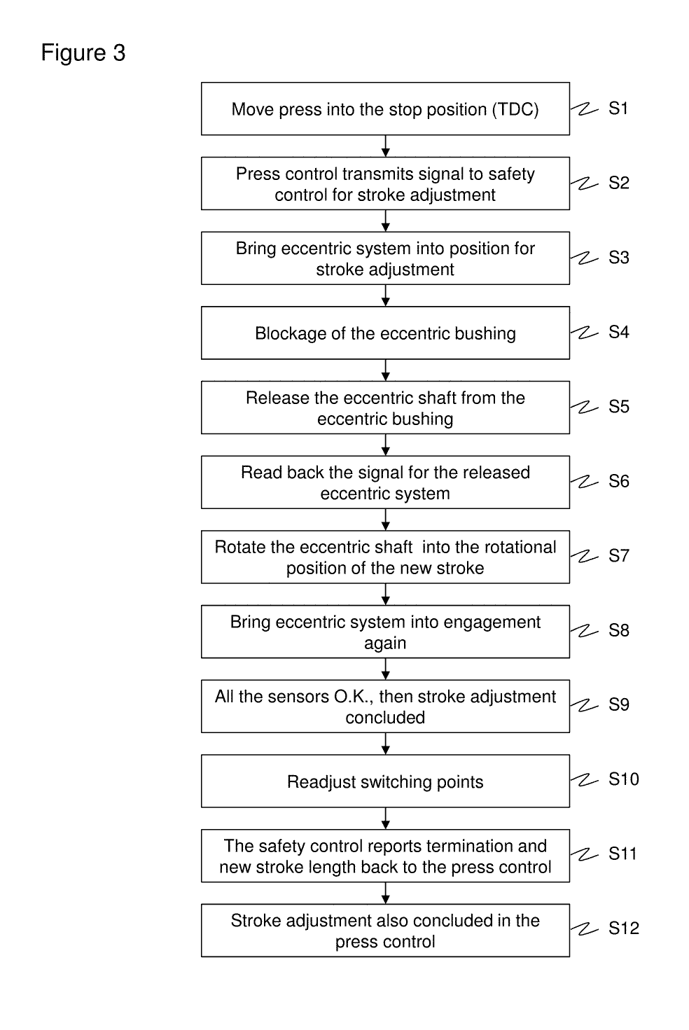

FIG. 3 a flowchart for the adjustment of the stroke length and for the readjustment of the switching points;

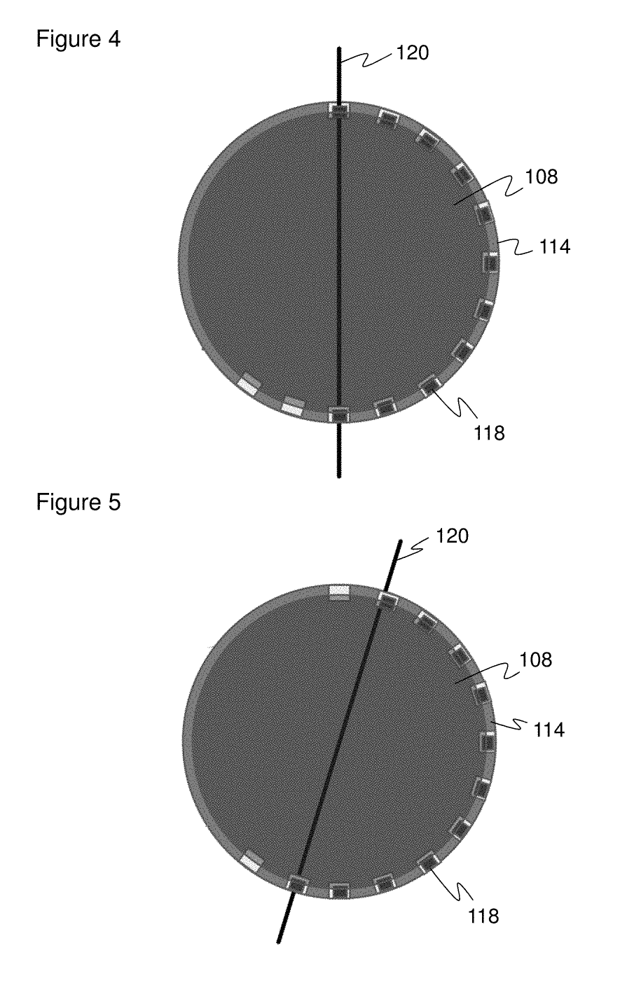

FIG. 4 a representation of the eccentric system in a position for a first stroke length;

FIG. 5 a representation of the eccentric system in a new position for a second stroke length;

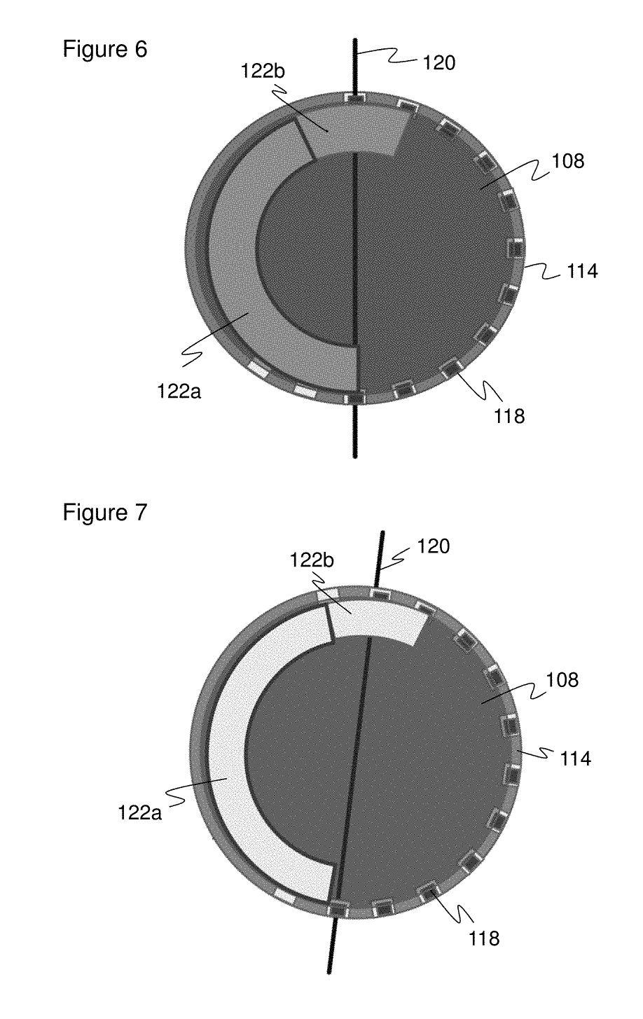

FIG. 6 a representation of the eccentric system and of the switching points in the position for a first stroke length in accordance with FIG. 4,

FIG. 7 a representation of the eccentric system and of the switching points in the new position for a second stroke length in accordance with FIG. 6, and

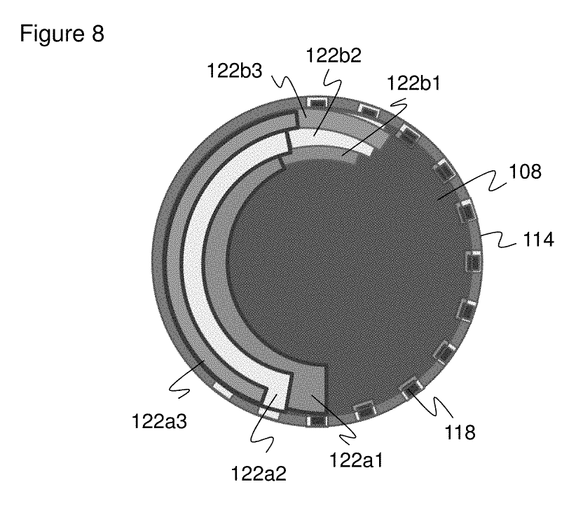

FIG. 8 a representation of the eccentric system and of the switching points for three different stroke lengths.

FIG. 1 shows a block diagram of an eccentric press 100 having a safety control 10 for its monitoring. The design of the eccentric press 100 is considered as known and a large number of elements such as the motor, flywheel, transmission, brake, and the like are therefore not shown. The plunger 102 that is moved up and down by an eccentric system 106 via a connecting rod 106 is only shown in a more symbolic manner.

The eccentric system 106 has an eccentric shaft 108 that is set into rotational movement via the transmission, not shown. The eccentric shaft 108 more precisely comprises the actual shaft 110, that forms the axis of rotation and that is moved via the transmission, and an eccentric 112 connected thereto; however, this is no longer distinguished in the following. The eccentric shaft 108 is connected to an eccentric bushing 114 via a toothed arranged, for example.

To adjust the stroke length of the eccentric shaft 100, the eccentric shaft 108 can be pneumatically or hydraulically released from the eccentric bushing 114 and can be rotated against it. The eccentric shaft 108 then only latches in specific discrete rotational positions again so that only a stepped adjustment of the stroke length is possible. Alternatively, presses having force transmission in their eccentric systems are also conceivable that then permit a continuous adjustment.

The routines of the eccentric press 100 are controlled by a press control 116 that is in particular able to set the eccentric shaft 108 into a rotational movement and to stop it. The press control 116 is connected to the safety control 10.

A plurality of safe sensors are connected to the safety control 10 to monitor the eccentric press. A safe absolute encoder 12 determines the respective rotational position of the eccentric shaft 108. During normal operation, the total eccentric system 106 can be understood as a mechanical unit so that rotational position of the eccentric bushing 114 and ultimately of the plunge 102 is also detected with the rotational position of the eccentric shaft 108. The safety control 10 generates switching signals corresponding to specific positions of the plunger 102 in specific rotational positions of the eccentric shaft 108. This is described here for the example of the switching points BDC at the bottom dead center, TDC at the top dead center, and SCC at the readjustment point. Where permitted and sensible, more, fewer and/or other switching points can be taken into account. The absolute encoder 12 in combination with the safety control 10 consequently replaces the conventional mechanical cam switch.

An eccentric separation monitoring sensor 14 recognizes when the eccentric shaft 108 is released from the eccentric bushing 114 to adjust the stroke length. For example, a rising flank indicates that the eccentric system 106 is released and conversely a falling flank indicates that the eccentric system 106 is fixedly connected. The eccentric monitoring sensor 14, for example, has two antivalent safety position switches.

In the released state of the eccentric system 106, the eccentric shaft 108 and the eccentric bushing 114 can rotate independently of one another and must be considered as independent units. A position monitoring sensor 16 for the eccentric bushing 114 is therefore provided. It can be a second safe absolute encoder or another sensor to safely monitor the position of the eccentric bushing 114. The eccentric bushing 114 is preferably, however, blocked during a stroke adjustment, with the corresponding blockage, not shown, likewise being controlled by the safety control 10. With a blocked eccentric bushing 114, the further drive of the eccentric press 100 has the result that the eccentric shaft 108 is rotated against the fixed eccentric bushing 114. The eccentric bushing 114 does not have any rotational degree of freedom of its own, which simplifies the adjustment procedure per se and equally the required controls and readjustments. The position monitoring sensor 16 can be configured as a switch, for example as a contactless inductive safety switch, that does not monitor any rotational positions of the eccentric bushing 114, but only ensures that it is actually blocked.

The safety control 10 has all the required information from the sensors 12, 14, 16 to safely adjust the stroke length and to readjust the switching points. In addition, the safety control 10 can also be responsible for safety sensors, not shown, for instance a light grid that secures the material supply and that is deactivated or muted after reaching the bottom dead center up to the top dead center.

FIG. 2 shows a diagram that explains the angles in the eccentric system 106 on the adjustment of the stroke length. e1 here stands for the eccentric shaft 108 and e2 for the eccentric bushing 114. The eccentric shaft 106 is rotated by the angle β to arrive at the new stroke length from the original stroke length. That angle is designated by γ by which the eccentric system 106 is rotated from the original stroke length to the new stroke length. This is at the same time the correction angle by which the switching points have to be readjusted. The angle μ of the plunger 102 is also drawn.

If the eccentric bushing 114 is blocked for the stroke length adjustment, a further movement of the eccentric shaft 106 then changes the angle β and thus the angle between e1 and e2. The angle γ is thereby also affected and the switching points have to be correspondingly corrected by −γ.

FIG. 3 shows a flowchart for the adjustment of the stroke length and for the readjustment of the switching points. Individual steps are here additionally illustrated in FIGS. 4 to 7.

In a step S1, the eccentric press 100 is brought in a preparatory manner into the starting position at the top dead center TDC. This is not absolutely necessary for the subsequent traveling per se, but the operation and movement of the eccentric press 100 should be interrupted.

In a step S2, the press control 116 transmits a signal to the safety control 10 by which a stroke adjustment is requested and possibly information on the desired new stroke length. The safety control 10 monitors the observation of the process steps defined for the stroke adjustment by an internal status machine, for example, with whose aid the stroke setting is determined.

In a step S3, the eccentric system 106 is traveled into a position by means of the press control 116 in which a stroke adjustment is possible. This position is defined via the mechanical design of the press and is stored in the safety control. A comparison takes place in the safety control whether the current position of the eccentric shaft corresponds to the stored desired position, i.e. to the current stroke length position. A check is furthermore made that the eccentric bushing is likewise in the expected position or setting.

In a step S4, the further movement of the eccentric bushing 114 is blocked so that it can no longer change its position. The safety control 10 addresses a corresponding connected actuator for this purpose.

In a step S5, the eccentric shaft 108 is released from the eccentric bushing 114 by a control command of the safety control 10, preferably communicated by the press control 116, to a corresponding pneumatic circuit of the eccentric press 100. The eccentric separation monitoring sensor 14 monitors this process.

The separation is also checked again by a reading back of the signal in a step S6.

In a step S7, the eccentric shaft 108 is now rotated against the eccentric bushing 114. This is illustrated for an example in FIGS. 4 and 5. FIG. 4 shows the starting situation; FIG. 5 shows the situation after adjustment of the stroke length. The eccentric shaft 108 and the eccentric bushing 114 are respectively shown above one another, with only circles without eccentricity being shown in order not to overload the representation. An arrangement 118 of teeth and grooves provides the shape match in the eccentric system 106. The engagement of the teeth in the grooves is canceled by the release in step S5 that corresponds to a raising of the eccentric shaft 106 from the plane of the paper. A diameter 102 is intended to illustrate the rotation during the stroke length adjustment.

In the starting position of FIG. 4, an original stroke length setting is adopted in which γ=0 and β=0 applies to the angles explained with regard to FIG. 2. After the rotation of the eccentric shaft in step S7, the eccentric shaft 108 is in a new position in accordance with FIG. 5, with in this example the new values γ=10° and β=20° being reached.

In a step S8, the eccentric system 106 is again brought into engagement after reaching the desired rotational position. In FIG. 5, the eccentric shaft 108 is consequently again lowered into the plane of the paper so that the teeth engage into the grooves in the arrangement 118.

The stroke adjustment is concluded in principle in a step S9. The requirement for this is, on the one hand, that the rotation reached in the eccentric system corresponds to a permitted stroke length adjustment. For this purpose, the shape match in the arrangement 118 must primarily be possible, for which purpose the teeth have to be rotated such that they can slide into the grooves, which is evidently only possible in specific discrete positions with a small angle tolerance. The possible stroke positions are stored, for example, as a configuration in the safety control 10. This check is omitted in an alternative continuous stroke length adjustment without the arrangement 118, for example with a force transmission instead of the shape matching.

In addition, on the one hand, the eccentric separation monitoring sensor 14 should have reported, exactly between the steps S5 to S8, that the eccentric shaft 108 was out of engagement with the eccentric bushing 114. On the other hand, the eccentric bushing 114 must have maintained its position, that is may not have rotated despite a blockage. This is ensured by an evaluation of the signals of the position monitoring sensor 16. If the desired position of the eccentric system 106 has now been reached and if all the sensors 12, 1, 16 report that the adjustment process was permitted and has run in accordance with the safety requirements, the new stroke length can be activated.

However, the switching points of the “virtual cam switch” are previously readjusted in a step S10. As already explained, the safety control 10 is able to output a respective switching signal at specific points in the press cycle on the basis of the rotational position of the eccentric shaft 106 measured by the absolute encoder, such as at the bottom dead center BDC, at the top dead center TDC, and at a readjustment point SCC. These switching points are shifted by the adjustment of the stroke length.

FIGS. 6 and 7 illustrate the readjustment of the switching points. The representations correspond to FIGS. 4 and 5, i.e. to a starting situation and to the situation after the adjustment of the stroke length. Respective virtual cams 112a-b are additionally drawn that in turn are only a special kind of illustration of the switching points stored in the safety control.

In the starting position of FIG. 6, the bottom dead center BDC is T 180°, the top dead center TDC is at 355°, and the readjustment point SCC is at 15°. After the adjustment of the stroke length in the situation in accordance with FIG. 7, the switching points have been shifted by the angle γ so that a correction by −γ is required. Since FIG. 6 is the starting situation to which reference is made, γ=−γ=0 here. In contrast, in the situation in accordance with FIG. 7, a correction by −γ=−10° has to take place.

The required correction angles γ in dependence on the angle β measured by means of an absolute rotary encoder are stored as parameters in the safety control 10 and are then activated in the safe application software after a successful adjustment procedure. The numerical values of the correction angles and the permitted adjustment angles 13 depend on the respective eccentric press 100. They are preferably specified by the manufacturer of the eccentric press 100. Alternatively, it is also possible to calculate this from the geometry of the eccentric system 106 or to determine the correction angles once by manual teaching. In principle, a calculation rule could also be implemented in the safety control 10; however, the effort is typically in no relation to the use in view of the manageable number of possible stroke lengths.

The process is ended with the readjustment of the switching points. The safety control 10 reports this in a step S11 back to the press control 116, with the new stroke length also being able to be transmitted again. The press control 116 can carry out a further validation of the information.

The procedure is thus also terminated in a step S12 for the press control 116 and the eccentric press 100 can take up its operation with the new stroke length.

The described distribution of work between the safety control 10 and the press control 116 is advantageous because the safety control is specifically responsible for the safety aspects and is correspondingly adapted thereto, for instance by redundancies, a two-channel design, and a self-test against failures and defects. The work can nevertheless also be differently distributed and, for example, all the functions can then be transferred into a then correspondingly safe press control 116.

Furthermore, not all the steps are compulsory in this form and order. The eccentric bushing 114 can, for example, have a movement permitted to it instead of blocking it in step S4, with the rotation then being safely monitored and taken into account. A check whether a rotational position for the eccentric system is permitted is omitted with a continuous stroke adjustment. The readjustment of the switching points was described in step S10 after termination of the stroke adjustment, but can also take place at the same time or in advance, with in the latter case, the new switching points naturally only becoming valid if the stroke length was actually successfully set.

FIG. 8 again shows the switching points for three different stroke lengths in a representation similar to FIG. 6 or FIG. 7. The switching points are in turn illustrated by virtual cams 122a1 . . . 122b3. It can be derived from this representation how a larger number of different stroke lengths can also be processed.

1. A safe control apparatus for adjusting a stroke length of an eccentric press,
wherein the eccentric press has a plunger that is driven via a connecting rod by an eccentric system, the eccentric system comprising an eccentric shaft and an eccentric bushing, with the eccentric shaft and the eccentric bushing being able to be released from one another and then rotated against one another for the adjustment of the stroke length;
wherein the safe control apparatus has an encoder for determining the rotational position of the eccentric shaft and a control logic to generate a first switching signal at at least one first rotational position,
wherein the control logic is configured to automatically readjust the first rotational position on an adjustment of the stroke length.

2. The safe control apparatus in accordance with claim 1,
wherein the control logic is configured to generate the first switching signal at a bottom dead center of the eccentric press and a second switching signal at a second rotational position at a top dead center of the eccentric press.

3. The safe control apparatus in accordance with claim 2,
wherein the control logic is configured to generate a third switching signal at a third rotational position at a readjustment point.

4. The safe control apparatus in accordance with claim 2,
wherein the control logic is configured to determine the rotational positions relative to one another.

5. The safe control apparatus in accordance with claim 1,
wherein the control logic has one of a table and a calculation rule that associates a respective correction angle for the first rotational position with possible angles the eccentric shaft and the eccentric bushing can adopt with respect to one another for the adjustment of the stroke length.

6. The safe control apparatus in accordance with claim 1,
wherein the encoder is configured as a safe absolute encoder.

7. The safe control apparatus in accordance with claim 1,
further comprising a position monitoring sensor for the eccentric bushing.

8. The safe control apparatus in accordance with claim 7,
wherein the position monitoring sensor is configured as a safety position switch that recognizes a blockage of the eccentric bushing.

9. The safe control apparatus in accordance with claim 1,
further comprising an eccentric separation monitoring sensor that recognizes whether the eccentric shaft and the eccentric bushing are released from one another or not.

10. The safe control apparatus in accordance with claim 1,
wherein the control logic is configured to recognize whether an angle between the eccentric shaft and the eccentric bushing selected on the adjustment is permitted.

11. The safe control apparatus in accordance with claim 1,
wherein the control logic is configured to automatically adjust the stroke length.

12. A method for the safe adjustment of a stroke length of an eccentric press that has a plunger that is driven via a connecting rod by an eccentric system, the eccentric system comprising an eccentric shaft and an eccentric bushing, with the eccentric shaft and the eccentric bushing being released from one another and being rotated against one another for the adjustment of the stroke length, with the rotational position of the eccentric shaft being determined in operation by an encoder and with a switching signal being generated on a respective reaching of at least one rotational position,
wherein the first rotational position is automatically readjusted on an adjustment of the stroke length.

13. The method in accordance with claim 12,
wherein a desired stroke length is predefined for the automatic adjustment of the stroke length and the eccentric shaft is thereupon rotated by a required angle against the eccentric bushing.

14. The method in accordance with claim 12,
wherein the eccentric press is first moved into a position suitable for the adjustment of the stroke length.

15. The method in accordance with claim 12,
wherein the eccentric shaft is released from the eccentric bushing and the eccentric bushing is blocked, the eccentric press is then driven until the eccentric shaft is rotated by a required angle against the eccentric bushing, and the eccentric shaft is subsequently again connected to the eccentric bushing.

16. The method in accordance with claim 13,
wherein the eccentric shaft is released from the eccentric bushing and the eccentric bushing is blocked, the eccentric press is then driven until the eccentric shaft is rotated by the required angle against the eccentric bushing, and the eccentric shaft is subsequently again connected to the eccentric bushing.
